(19) United States
(12) Patent Application Publication
(10) Pub. No.: US 2020/0128113 A1
(43) Pub. Date: Apr. 23, 2020

(54) EFFICIENT REASSEMBLY OF INTERNET PROTOCOL FRAGMENT PACKETS

(71) Applicant: NXP USA, Inc., Austin, TX (US)

(72) Inventor: Vijaya Kumar Ambati, Hyderabad (IN)

(21) Appl. No.: 16/167,734

(22) Filed: Oct. 23, 2018

(51) Int. Cl. H04L 29/06; H04L 29/08; H04L 12/741

(52) U.S. Cl. CPC H04L 69/166; H04L 69/161; H04L 45/74; H04L 69/329; H04L 63/0485; H04L 69/22

(57) ABSTRACT

A mechanism is provided that reduces the probability of datagram fragmentation reassembly failure due to wrapping of the IP identification field by adding an additional parameter for a receiving protocol module to identify packets associated with a fragmented datagram. In doing so, in one embodiment, the theoretical maximum reassembly block limit can increase several orders of magnitude. In one embodiment of the present invention, the additional parameter considered by the receiving protocol module is the 6-bit differentiated services code point (DSCP) identifier.

### BACKGROUND

### Field

This disclosure relates generally to network packet fragmentation, and more specifically, to reducing fragment reassembly errors in high data rate situations.

### Related Art

The Internet Protocol (IP) v4 header was designed at a time when data rates were orders of magnitude lower than those achievable today. Consequently, there is a scale-related failure in the IP identification (ID) field in which fragments may be incorrectly assembled at a rate high enough to significantly effect data integrity failure rates.

As is discussed in the Internet Protocol standard, the choice of an IP identifier for a datagram is based on a need to provide a way to uniquely identify fragments of a particular datagram. A receiver's protocol module assembling datagram fragments determines that fragments belong to the same datagram if the fragments have a same IP source, IP destination, protocol, and IP identifier. Thus, the IP identifier must be unique for a source, destination, and protocol tuple for the time the datagram or its fragments could be alive in the network.

Since the identification field in the IP packet header is 16 bits, unique transmissions in one direction between any address pair are limited to no more than 65536 packets per protocol per maximum packet lifetime. IP receivers store fragments in a reassembly buffer until all fragments in a datagram arrive, or until the reassembly timeout expires. If a sender wraps the ID field in less than the reassembly timeout, it is possible for fragments from different datagrams to be incorrectly spliced together (i.e., misassociated), and delivered to an upper layer protocol. In addition, when misassociated fragments are delivered, transport-layer checksumming should detect the datagrams as incorrect and discard those datagrams. When the datagrams are discarded, a performance problem can arise for a loss-feedback congestion algorithm, where a certain amount of non-congestive loss is introduced. This can cause issues in which the transport layer checksum is not designed to handle such high error rates.

Thus, it is desirable to have a mechanism which reduces the probability of fragment reassembly failure due to wrapping of the IP identification field in high data rate communication.

### BRIEF DESCRIPTION OF THE DRAWINGS

Embodiments of the present invention may be better understood by referencing the accompanying drawings.

FIG. 1 is a simplified block diagram illustrating an example of a network connection between nodes separated by gateways and a wide area network.

FIG. 2 is a simplified diagram illustrating an IPv4 packet used by embodiments of the present invention.

FIG. 3 is a table illustrating information that may be related to differing packet flows that can pass between two hosts.

FIG. 4 is a table illustrating an example of packet identification, fragmentation, and successful reassembly for the three flows illustrated in FIG. 3.

FIG. 5 is a table illustrating an example of packet identification, fragmentation, and packet loss with unsuccessful reassembly for a flow of the three flows illustrated in FIG. 3.

FIG. 6 is a table illustrating an example of packet identification, fragmentation, and reassembly for the flows illustrated in FIG. 3, where packet fragment identification includes the DSCP.

FIG. 7 is a simplified block diagram illustrating an example of an alternative network connection between nodes separated by gateways and a wide area network in which fragmentation issues can be alleviated by embodiments of present invention.

FIG. 8 is a simplified block diagram illustrating a packet routing device usable with embodiments of the present invention.

The use of the same reference symbols in different drawings indicates identical items unless otherwise noted. The figures are not necessarily drawn to scale.

### DETAILED DESCRIPTION

Embodiments of the present invention provide a mechanism that reduces the probability of datagram fragmentation reassembly failure due to wrapping of the IP identification field by adding an additional parameter for a receiving protocol module to identify packets associated with a fragmented datagram. In doing so, in one embodiment, the theoretical maximum reassembly block limit can increase from the current 65535 to 4195240. In one embodiment of the present invention, the additional parameter considered by the receiving protocol module is the 6-bit differentiated services code point (DSCP) identifier.

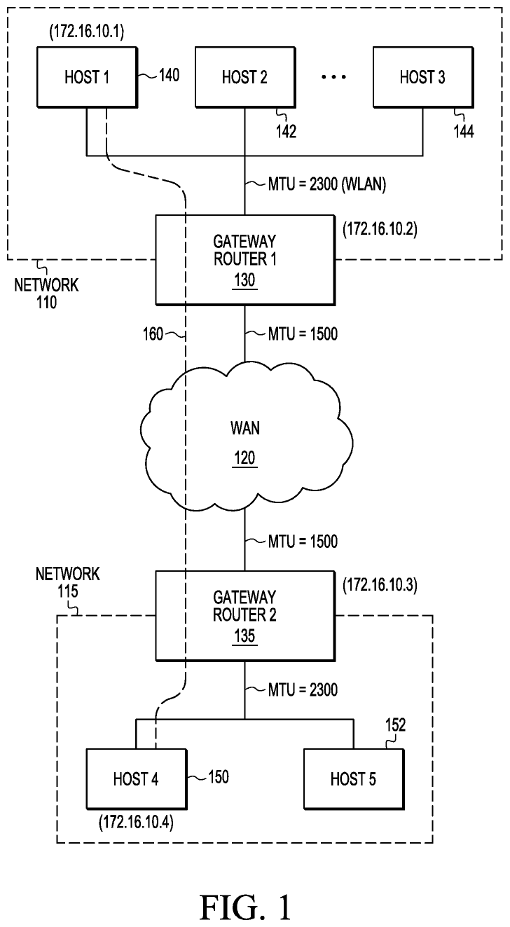

FIG. 1 is a simplified block diagram illustrating an example of a network connection between nodes separated by gateways and a wide area network. A network 110 and a network 115 are coupled to one another through a wide area network (WAN) 120. Each of network 110 and 115 are coupled to WAN 120 via gateway router 1 (130) and gateway router 2 (135), respectively. Network 110 further includes Host 1 (140), Host 2 (142), and Host 3 (144), which are communicatively coupled with each other and with gateway router 1 (130). The communicative coupling can be provided using cabling, optical fibre, wireless communication, and the like, depending upon the nature of the applications exercised by the hosts in the network. Similarly, network 115 includes Host 4 (150) and Host 5 (152) that are communicatively coupled with gateway router 2 (135). The communicative coupling in network 115 can be the same or different from that provided in network 110.

Gateway Router 1 (130) provides network packets from hosts in network 110 to receiver nodes in networks external to network 110 via WAN 120. In addition, network packets from hosts external to network 110 must communicate to hosts within network 110 via gateway router 1. FIG. 1 illustrates an example of a path 160 between Host 1 (140) in network 110 and Host 4 (150) in network 115. Packets associated with flows between Host 1 and Host 4 pass through Gateway Router 1 and Gateway Router 2 and other intermediate network nodes located within WAN 120. In order to properly route packets along path 160, routing nodes along the path read portions of packet headers that provide information related to the route.

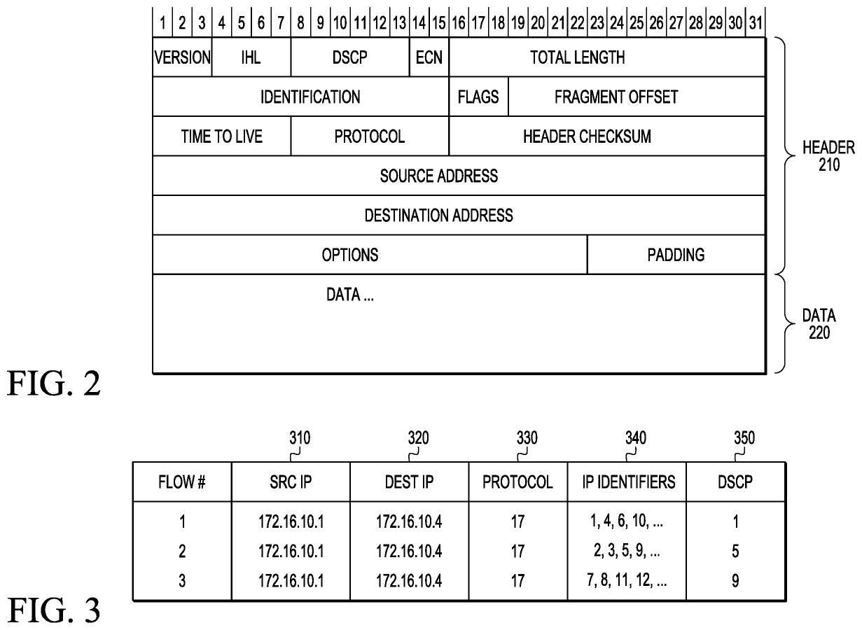

FIG. 2 is a simplified diagram illustrating an IPv4 packet used by embodiments of the present invention. As illustrated, the packet is divided into at least two portions: packet header 210 and packet data 220. The five 32-bit word IP packet header provides information identifying the packet and the flow of which the packet is a part. The various fields are described in detail in Internet Protocol documents, such as RFC 791. In brief, the fields are as follows:
Version: IP version (e.g., 4 or 6)
IHL (IP header length): Number of 32 bit words forming the header (e.g., 5)
DSCP (Differentiated Services Code Point): reflects a Quality of Service or Type of Service related to needs of an application generating the packet
ECN (Explicit Congestion Notification): designates whether packet uses ECN
Total Length: combined length of header and data of the packet
Identification: uniquely identifies packet along with Source and Destination (described in greater detail below)
Flags: control whether router may fragment a packet
Fragment Offset: byte count from start of original sent packet, as set during fragmentation
Time To Live: number of hops/links over which a packet may be routed
Protocol: indicates type of transport packet (e.g., 6=TCP, 17=UDP)
Header Checksum: 1's complement checksum inserted by sender and updated by routers that modify the packet
Source Address: IP address of original sender of packet
Destination Address: IP address of final destination of packet
Options/Padding: not normally used
   Each router on a path that a packet takes through a network will read all or a portion of the packet header and make decisions on how to treat the packet in light of the header information. For example, information regarding how to route a packet in light of the packet's destination will be stored in routing lookup tables in a router (e.g., a next hop to which to send the packet).

FIG. 3 is a table illustrating information that may be related to differing packet flows that may pass between two hosts. In this case, the flows are along path 160 in FIG. 1 between Host 1 (140) and Host 4 (150). Host 1 has an IP address of 172.16.10.1 and Host 4 has an IP address of 172.16.40.4. As illustrated in FIG. 3, three different flows are routed between the hosts. Packets within those flows are identified by a tuple of Source IP address, Destination IP address, Protocol, and IP Identification. The Identification is assigned to the packet when the original packet is generated and is associated not only with the packet but with all packets containing fragments of a datagram. The examples illustrated in FIG. 3 will be used in scenarios discussed below.

Datagram fragment packets are generated when an original packet or datagram contains more data than can be sent on a transmission path. Typically, the maximum amount of data that can be transmitted on a transmission link is related to the technology medium underlying the link. For example, a maximum frame size for an Ethernet v2 link is 1518 bytes. Of these 1518 bytes, 18 bytes are overhead (e.g., header and frame check sequence), thus the maximum amount of data that can be contained is 1500 bytes. This maximum amount of data is called the maximum transmission unit (MTU). The MTU is the size of the largest protocol data unit that can be communicated in a single network transaction. MTUs associated with other IP media are, for example: WLAN (802.11)=2304; Token Ring (802.5)=4464; and, FDDI=4325.

Transmission links having differing MTUs can be on a path between two communicating hosts. If a packet originates in a network associated with a larger MTU but then passes between intermediate nodes on a link having a smaller MTU, then the packet may be fragmented to allow it to pass through the smaller MTU link. That is, the large packet is subdivided into smaller packets that conform with the smaller MTU value. This can be done either at the originating host or at an intermediate router coupled to the smaller MTU link. If performed at the originating host, the host identifies the smallest MTU along the path and then determines whether an L4 protocol data unit needs to be fragmented to form packets for transmission along that path. Packet fragments will be reassembled at the packets' destination. As illustrated in FIG. 1, networks 110 and 115 have associated MTUs of 2300, while the links along WAN 120 have an associated MTU of 1500. Thus, while larger packets can be transmitted between nodes internal to network 110 or 115, those packets must be fragmented to pass between the two networks along the WAN. Again, fragmentation can be performed either at the gateway routers or at the originating host.

As discussed above, each fragment associated with a packet is uniquely identified to be associated with that packet so that a receiving node can reassemble the packet. The IPv4 header fields associated with packet fragmentation include the Identification field, the Flags field, and the Fragment Offset. The Identification field is a 16-bit field whose value is assigned by the network node generating the packet fragments. The Flags field tells nodes reading the packet whether the packet can be fragmented. The Fragment Offset field specifies the offset or position of where the data in the fragment packet goes in the assembled packet in units of 8 octets (64 bits).

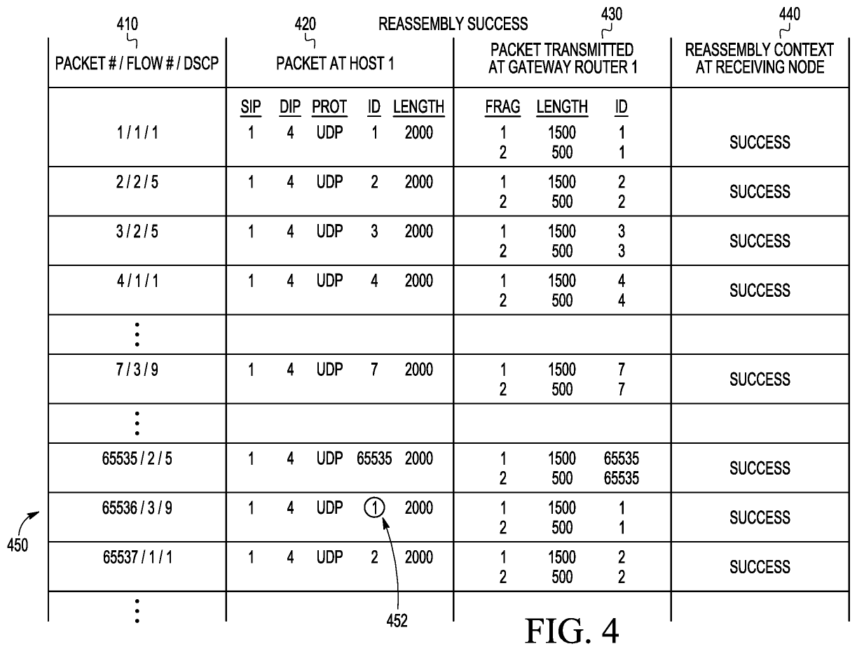

FIG. 4 is a table illustrating an example of packet identification, fragmentation, and successful reassembly for the three flows shown in FIG. 3. Column 410 provides the packet number, flow number (as associated with the flows in FIG. 3), and the DSCP identifier. Column 420 provides the identification 4-tuple information for each packet, along with a length of the packet. The packet length in this column (2000) is less than the MTU of network 110, but greater than the MTU of the links between the gateway routers. Thus, fragmentation of the packet by Gateway Router 1 will be required.

Column 430 shows the packet fragmentation for each packet being transmitted in FIG. 4. For simplicity, the fragmentation is shown as dividing each packet into two fragments (Fragment 1 and 2) where the first fragment is 1500 bytes and the second fragment is the remaining 500 bytes. The identifier for each packet fragment is assigned by the node performing the fragmentation (e.g., gateway router 1). Column 440 shows the reassembly context at the receiving node. In this example, all reassemblies are successful.

It should be noted that, at packet number 65536 (450), the IP identifier wraps back to 1 (452). As discussed above, this is because the IP identifier field is 16-bits. In the example of FIG. 4, however, the wraparound does not create an issue because all fragments arrive at the receiving node and the packets are assembled. Alternatively, if the time to live of packet fragments is shorter than the time for the IP identifier value to wrap around, then there will not be an issue with mismatched packets.

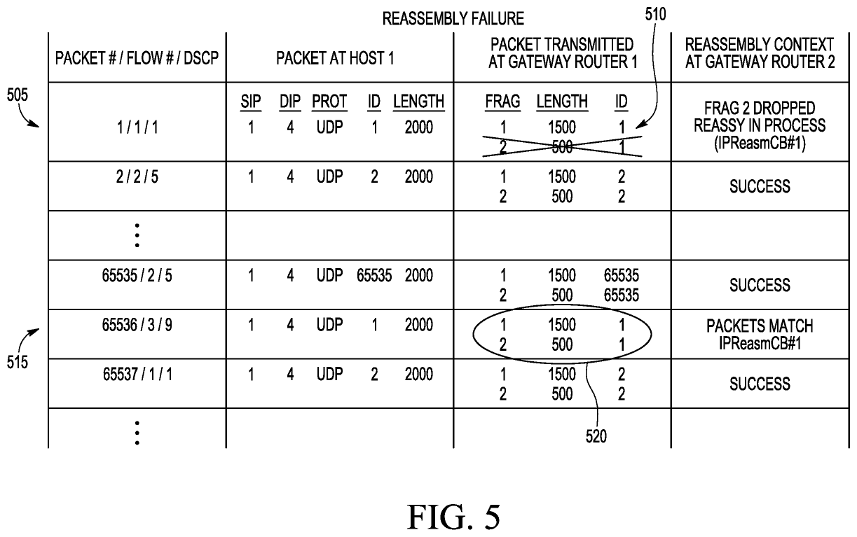

FIG. 5 is a table illustrating an example of packet identification, fragmentation, and packet loss with unsuccessful reassembly for a flow of the three flows shown in FIG. 3. The columns are the same as those illustrated in FIG. 4. In the first packet (505), the second fragment is lost during transmit (510). A packet fragment can be lost due to errors in data transmission or network congestion. Since the fragment of packet 1 is lost between gateway router 1 and the receiving node, the receiving node will wait to receive the second fragment until the end of a reassembly timer period for the packet or until the receiving node receives all fragments of the packet.

As with FIG. 4, a packet #65536 (515) is generated and receives an IP identifier of 1 and that packet is fragmented (520). The 4-tuple identifying the fragments of this packet is the same as that identifying packet #1 (i.e., SIP=1, DIP=4, PROT=UDP, ID=1). If the receiving node is still waiting for the lost fragment of packet #1 at the time fragments of packet #65536 are received, then the first fragment of packet #65536 will be dropped by the receiver as a duplicate and the second fragment of packet #65536 will be combined with the first fragment of packet #1. This wrongly combined packet information will be provided to the protocol layer at which time the packet will likely fail a checksum validation and the packet will be dropped. The receiving node can then request packet #1 to be resent along with packet #65536.

The above process of wrongly assembling packets, dropping the bad packets, and requesting re-transmission of the packets decreases efficiency of the network and also increases network congestion with re-transmitted packets. For high speed networks, the probability of wraparound of IP identifiers occurring is significant. For example, given a 1500 byte size packet, a 10 Gbps data rate will be equivalent to about 833,333 PPS. At that packet rate, the probability of repeating the same IP identifier in one second is 833,333/ 65535=12.7. Thus, if a reassembly timer for a fragmented packet is 1 second, then more than 12 times during that period there is a chance than another packet's fragment will match and the wrongly reassembled packet will be discarded.

Embodiments of the present invention are configured to decrease the probability of wraparound IP identifiers causing wrongly assembled packets, and thus improve the performance of the network transporting the fragmented packets. Embodiments accomplish this by including an additional identifier value to the tuple that uniquely identifies packets and packet fragments, making a 5-tuple instead of a 4-tuple. In order to avoid modifying standards for network packets, embodiments of the present invention use an already existing field in the IP packet header for the modified tuple.

In one embodiment, the differentiated services code point (DSCP) identifier is included in the tuple that includes source IP address, destination IP address, protocol, and IP identifier. Thus, flows having differing DSCP identifiers will be distinguished from one another during packet fragment reassembly. Since the DSCP identifier is a required 6-bit field, there are 64 unique DSCP codes that can be used to differentiate packet in flows between hosts. In practice, there are 21 commonly-used DSCP identifiers with a default DSCP of 0. By including the DSCP in the packet identification tuple, the probability of a wraparound in the IP identifier field causing a wrongly assembled packet is significantly reduced (e.g., 833,333/4,194,304=0.199).

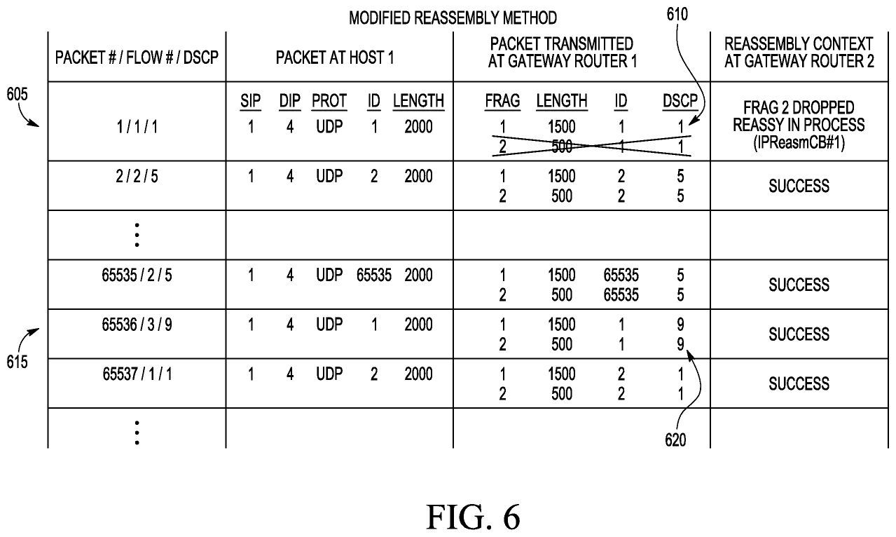

FIG. 6 is a table illustrating an example of packet identification, fragmentation, and reassembly for the flows shown in FIG. 3 wherein packet fragment identification includes the DSCP. As illustrated in FIG. 5, packet #1 (605) is fragmented and the second fragment is lost during transmit (610). Again, the receiving node will wait to receive the second fragment until the end of the reassembly timer period for the packet or until the receiving node receives all fragments of the packet. Packet #65536 (615) is generated and receives an IP identifier of 1 and that packet is fragmented (620). As discussed for FIG. 5, if a standard 4-tuple of SIP, DIP, PROT, and ID is used to identify packet fragments, the identifiers of both packet #1 and #65536 would be the same. But if the packet fragments are identified by a 5-tuple that includes DSCP, then the identifier of packet #65536 is distinct from that of packet #1 and there will be no confusion between the fragments of the latter packet with the former. Thus, packet #65536 will be successfully reassembled even though the receiving node will still be waiting for the missing packet of packet #1.

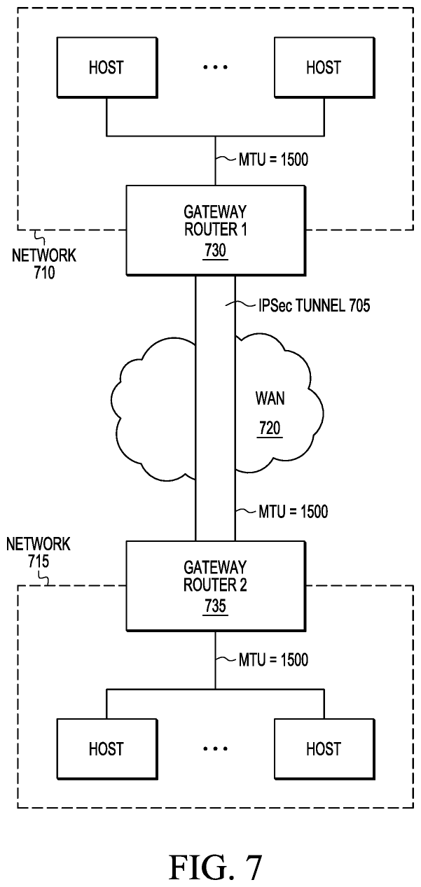

FIG. 7 is a simplified block diagram illustrating an example of an alternative network connection between nodes separated by gateways and a wide area network in which fragmentation issues can be alleviated by embodiments of present invention. In FIG. 7, an IP security (IPSec) tunnel (705) is provided between Gateway Router 1 (730) of network 710 and Gateway Router 2 (735) of network 715 through wide area network 720. Even though network 710 and network 715 have the same MTU as WAN 720, the use of an IPSec tunnel requires packets from network 710 and 715 to be encrypted and wrapped in a new IP header. This increases the length of the original packet, which then can exceed the MTU of the WAN. Thus, the IPSec packets are fragmented and transmitted across the WAN through the tunnel and reassembled at the destination end of the tunnel. Alternatively, unencrypted packets can be fragmented, then encrypted and sent through the tunnel. At the receiving end, the packets are unencrypted, then reassembled. This is so-called red-side fragmentation. In both instances, use of embodiments of the present invention to identify packet fragments can decrease reassembly errors, as discussed above.

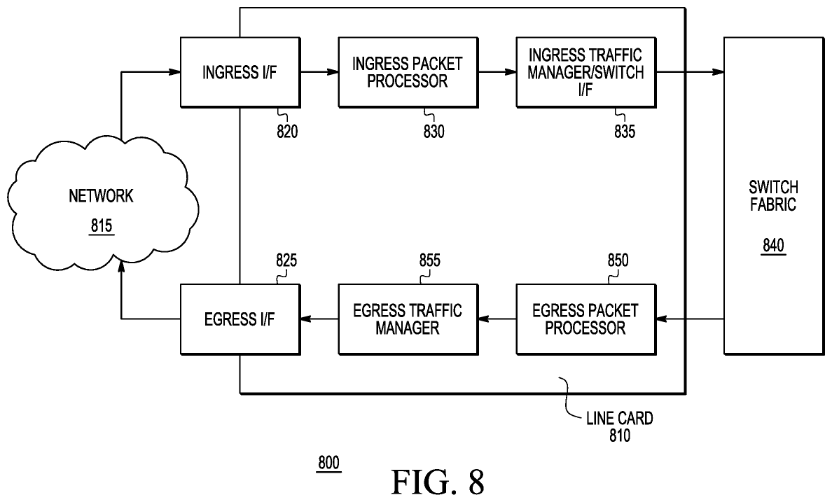

FIG. 8 is a simplified block diagram illustrating a packet routing device 800 usable with embodiments of the present invention. Routing device 800 includes a set of line cards 810 and a switch fabric 840. Each line card 810 includes one or more ingress interfaces 820 and one or more egress interfaces 825. As will be understood, the ingress interfaces and the egress interfaces can be implemented in shared circuitry such as a shared port adapter, which include one or more physical interfaces to a network 815 and are configured to perform operations on ingress and egress frames, such as OSI Layer 2.

Ingress interface 820 provides incoming packets to ingress packet processor 830. The ingress packet processor can be a multi-processing, multi-pipelined processor configured to perform a series of operations on incoming packets. The ingress packet processor can perform analysis of incoming packet headers and support edge features such as classification and flow statistics based upon information in headers. The ingress packet processor can perform analysis on protocols such as IPv4, IPv6, and MPLS packets. Such protocol processing can include the processing associated with packet fragmentation described above. Ingress Traffic Manager/Switch Interface 835 receives the processed packets from ingress packet processor 830 and can then perform packet buffering, queue management, ingress traffic shaping, and packet dropping. The ingress traffic manager/ switch interface 835 can then prepare the packet for transmission through switch fabric 840 (e.g., uniform, identified cells).

Once the packets are transmitted through switch fabric 840, egress packet processor 850 reassembles the switch fabric cells into packets and performs additional protocol driven operations on the packets, include fragmenting the packets if necessary for the coupled network. The egress packet processor then provides the outgoing packets to egress traffic manager 855, which prepares the packets for transmission and queues the packets to egress interface 825. Egress interface 825 formats the packets appropriately for the physical network coupled to the line card and transmits the packets to network 815.

By now it should be appreciated that there has been provided in one embodiment a method for associating internet protocol (IP) fragment packets. The method includes reading a header of a received IP packet, determining that a received IP packet is a fragment packet using a flag value in the header, and determining if the received IP packet is associated with a previous fragment packet that arrived prior to the received IP packet if the received IP packet is a fragment packet. The header includes an IP address of a source host of the IP packet, an IP address of a destination host of the IP packet, a protocol identifier, a differentiated services code point (DSCP) identifier, and an IP identifier. Determining the association between the received IP packet and the previous fragment packet includes comparing all of the source IP address, destination IP address, protocol identifier, DSCP identifier, and IP identifier of the received IP packet for matching values with respective values of the previous fragment packet, and if all of the values match then associating the received IP packet with the previous fragment packet.

In one aspect of the above embodiment, the method further includes, if the received IP packet is associating with the previous fragment packet, storing the received IP packet and the previous fragment packet until all fragment packets associated with the previous fragment packet are received, and reassembling the fragment packets into a complete datagram. In another aspect of the above embodiment, if the received IP packet is not associated with any previous fragment packet, storing the received IP packet until all fragment packets associated with the received IP packet are received, and reassembling the fragment packets into a complete datagram. In yet another aspect of the above embodiment, if the received IP packet is encrypted within an Internet Protocol Security (IPSec) packet having an IPSec header, decrypting the fragment packet prior to said reading the header of the received IP packet. In still another aspect of the above embodiment, if the received IP packet is a fragment of an IPSec packet, then using the IPSec packet header as the received IP packet header for said reading the header of the received IP packet header.

Another embodiment provides a network node coupled to a first network, where the network node includes a network interface coupled to the first network and configured to receive an IP packet, and a packet processor coupled to the network interface. The packet processor is configured to read a header of the received IP packet, determine that the received IP packet is a fragment packet using a flag value in the header, and determine if the received IP packet is associated with a previous fragment packet that arrived prior to the received IP packet if the received IP packet is a fragment packet. The header includes an IP address of a source host of the IP packet, an IP address of a destination host of the IP packet, a protocol identifier, a differentiated services code point (DSCP) identifier, and an IP identifier. Determining the association includes comparing all of the source IP address, destination IP address, protocol identifier, DSCP identifier, and IP identifier of the received IP packet for matching values with respective values of the previous fragment packet, and if all of the values match then associating the received IP packet with the previous fragment packet.

In one aspect of the above embodiment, the packet processor is coupled to a memory. If the received IP packet is associated with the previous fragment packet, then the packet processor is further configured to store, in the memory, the received IP packet and the previous fragment packet until all fragment packets associated with the previous fragment packet are received. Then the packet processor reassembles the fragment packets into a complete datagram. In another aspect of the above embodiment, the packet processor is coupled to a memory and further configured to, if the received IP packet is not associated with any previous fragment packet, store in the memory the received IP packet until all fragment packets associated with the received IP packet are received. Then the packet processor reassembles the fragment packets into a complete datagram. In yet another aspect of the above embodiment, the packet processor is further configured to decrypt the fragment packet prior to reading the header of the received IP packet if the received IP packet is encrypted within an IPSec packet having an IPSec header. In still another aspect of the above embodiment, the packet processor is further configured to use the IPSec packet header as the received IP packet header for reading the header of the received IP packet header if the received IP packet is a fragment of an IPSec packet.

Another embodiment provides a method for associating IP fragment packets. The method includes reading a header of a received IP packet, determining that a received IP packet is a fragment packet using a flag value in the header, and, if the received IP packet is a fragment packet, determining if the received IP packet is associated with a previous fragment packet that arrived prior to the received IP packet. The determining association includes comparing a 5-tuple of header field values of the received IP packet for matching values with respective values of a 5-tuple of the previous fragment packet, and if all the values match then associating the received IP packet with the previous fragment packet.

In one aspect of the above embodiment, the 5-tuple of header field values includes a DSCP identifier. In a further aspect, the 5-tupe of header field values further includes an IP address of a source host of the IP packet, an IP address of a destination host of the IP packet, a protocol identifier, and an IP identifier. In another aspect of the above embodiment, the method includes, if the received IP packet is associated with the previous fragment packet, storing the received IP packet and the previous fragment packet until all fragment packets associated with the previous fragment packet are received, and reassembling the fragment packets into a complete datagram. In another aspect of the above embodiment, the method includes, if the received IP packet is not associated with any previous fragment packet, then storing the received IP packet until all fragment packets associated with the received IP packet are received, and reassembling the fragment packets into a complete datagram.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 8 and the discussion thereof describe an exemplary router architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of any software described herein may be received elements of routig device 800, for example, from a computer readable media. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, just to name a few.

Although the invention is described herein with reference to specific embodiments, various modifications and changes can be made without departing from the scope of the present invention as set forth in the claims below. For example, the configurations of the networks illustrated in FIGS. 1 and 7 or the number of fragments into which a packet datagram may be divided. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for associating internet protocol (IP) fragment packets, the method comprising:
reading a header of a received IP packet, wherein the header comprises an IP address of a source host of the IP packet, an IP address of a destination host of the IP packet, a protocol identifier, a differentiated services code point (DSCP) identifier, and an IP identifier;
determining that the received IP packet is a fragment packet using a flag value in the header;
if the received IP packet is a fragment packet, determining if the received IP packet is associated with a previous fragment packet that arrived prior to the received IP packet, wherein
said determining association comprises comparing all of the source IP address, destination IP address, protocol identifier, DSCP identifier, and IP identifier of the received IP packet for matching values with respective values of the previous fragment packet, and if all of the values match then associating the received IP packet with the previous fragment packet.

2. The method of claim 1 further comprising:
if the received IP packet is associated with the previous fragment packet, then storing the received IP packet and the previous fragment packet until all fragment packets associated with the previous fragment packet are received, and
reassembling the fragment packets into a complete datagram.

3. The method of claim 1 further comprising:
if the received IP packet is not associated with any previous fragment packet, then storing the received IP packet until all fragment packets associated with the received IP packet are received, and
reassembling the fragment packets into a complete datagram.

4. The method of claim 1 further comprising:
if the received IP packet is encrypted within an Internet Protocol Security (IPSec) packet having an IPSec header, then
decrypting the fragment packet prior to said reading the header of the received IP packet.

5. The method of claim 1 further comprising:
if the received IP packet is a fragment of an Internet Protocol Security (IPSec) packet, then
using the IPSec packet header as the received IP packet header for said reading the header of the received IP packet header.

6. A network node coupled to a first network and comprising:
a network interface coupled to the first network and configured to receive an Internet Protocol (IP) packet;
a packet processor, coupled to the network interface, and configured to read a header of the received IP packet, wherein the header comprises an IP address of a source host of the IP packet, an IP address of a destination host of the IP packet, a protocol identifier, a differentiated services code point (DSCP) identifier, and an IP identifier;
determine that the received IP packet is a fragment packet using a flag value in the header;
if the received IP packet is a fragment packet, determine if the received IP packet is associated with a previous fragment packet that arrived prior to the received IP packet, wherein
said determining association comprises comparing all of the source IP address, destination IP address, protocol identifier, DSCP identifier, and IP identifier of the received IP packet for matching values with respective values of the previous fragment packet, and if all of the values match then associating the received IP packet with the previous fragment packet.

7. The network node of claim 6, wherein the packet processor is coupled to a memory and is further configured to:
if the received IP packet is associated with the previous fragment packet, then store, in the memory, the received IP packet and the previous fragment packet until all fragment packets associated with the previous fragment packet are received, and
reassemble the fragment packets into a complete datagram.

8. The network node of claim 6, wherein the packet processor is coupled to a memory and is further configured to:
if the received IP packet is not associated with any previous fragment packet, then store, in the memory, the received IP packet until all fragment packets associated with the received IP packet are received, and
reassemble the fragment packets into a complete datagram.

9. The network node of claim 7, wherein the packet processor is further configured to:
if the received IP packet is encrypted within an Internet Protocol Security (IPSec) packet having an IPSec header, then
decrypt the fragment packet prior to said reading the header of the received IP packet.

10. The network node of claim 6, wherein the packet processor is further configured to:
if the received IP packet is a fragment of an Internet Protocol Security (IPSec) packet, then
use the IPSec packet header as the received IP packet header for said reading the header of the received IP packet header.

11. A method for associating internet protocol (IP) fragment packets, the method comprising:
reading a header of a received IP packet;
determining that a received IP packet is a fragment packet using a flag value in the header;
if the received IP packet is a fragment packet, determining if the received IP packet is associated with a previous fragment packet that arrived prior to the received IP packet, wherein
said determining association comprises comparing a 5-tuple of header field values of the received IP packet for matching values with respective values of a 5-tuple of the previous fragment packet, and if all of the values match then associating the received IP packet with the previous fragment packet.

12. The method of claim 11, wherein the 5-tuple of header field values comprises:
a differentiated services code point (DSCP) identifier.

13. The method of claim 12, wherein the 5-tuple of header field values further comprises:
an IP address of a source host of the IP packet;
an IP address of a destination host of the IP packet;
a protocol identifier; and
an IP identifier.

14. The method of claim 11 further comprising:
if the received IP packet is associated with the previous fragment packet, then storing the received IP packet and the previous fragment packet until all fragment packets associated with the previous fragment packet are received, and
reassembling the fragment packets into a complete datagram.

15. The method of claim 11 further comprising:
if the received IP packet is not associated with any previous fragment packet, then storing the received IP packet until all fragment packets associated with the received IP packet are received, and
reassembling the fragment packets into a complete datagram.
